(19) United States
(12) Patent Application Publication
(10) Pub. No.: US 2023/0392572 A1
(43) Pub. Date: Dec. 7, 2023

(54) IGNITION DEVICE

(71) Applicant: Save The Planet Co., Ltd., Osaka (JP)

(72) Inventor: Mitsuhiro IZUMI, Osaka-shi (JP)

(21) Appl. No.: 18/175,814

(22) Filed: Feb. 28, 2023

(30) Foreign Application Priority Data
Jun. 7, 2022 (JP) 2022-091949

(51) Int. Cl. F02P 5/15

(52) U.S. Cl. CPC F02P 5/1502

(57) ABSTRACT

An ignition device is used in an internal combustion engine that uses a flame-retardant fuel. The ignition device includes a spark plug, a discharge circuit, and a control unit. The spark plug is placed in a cylinder of the internal combustion engine. The discharge circuit induces a high voltage in the spark plug, to thereby discharge the spark plug. The control unit controls a timing at which the spark plug is discharged by the discharge circuit. The control unit causes the discharge circuit to discharge the spark plug a plurality of times while a piston performs a reciprocating operation once in the cylinder. As a result, even when a flame-retardant fuel is used for the internal combustion engine, the ignition rate of the fuel can be enhanced.

### RELATED APPLICATIONS

This application claims the benefit of Japanese Application No. 2022-091949, filed on Jun. 7, 2022, the disclosure of which is incorporated by reference herein.

### BACKGROUND OF THE INVENTION

### Field of the Invention

The present invention relates to an ignition device for use in an internal combustion engine.

### Description of the Background Art

Conventionally, an ignition device for use in an internal combustion engine of an automobile is known. The ignition device includes a spark plug placed in a cylinder of the internal combustion engine. To drive the internal combustion engine, a piston in the cylinder compresses a fuel gas, and the ignition device causes spark discharge in the spark plug. This allows the fuel in the cylinder to burn.

Such a conventional ignition device is described in Japanese Patent Application Laid-Open No. 2013-68126, for example.

In the above-described kind of internal combustion engine, gasoline is conventionally used as a fuel. However, gasoline contains carbon, and so, when burning, it emits carbon dioxide that is a greenhouse gas. In recent years, global warming has become an issue gaining attention, and realization of decarbonized society is a matter of public concern. In view of this, as an alternative to gasoline, using ammonia containing no carbon for a fuel of an internal combustion engine is under consideration.

Nonetheless, ammonia is more flame-retardant than gasoline. For this reason, ammonia is not properly ignited by discharge of a spark plug in some cases. In a case where ammonia is used as a fuel, in particular, it is desirable to advance an ignition timing so that a timing of burning is not delayed. In such a case, the spark plug is discharged at a time point before a piston is at the top dead center. However, there arises a problem of further difficulties in igniting ammonia because the pressure and the temperature of the fuel in a cylinder do not have their maximum values at the time point before the piston is at the top dead center.

### SUMMARY OF THE INVENTION

The present invention has been made in view of the above-described circumstances, and it is an object of the present invention to provide an ignition device that can enhance an ignition rate of a flame-retardant fuel in using the fuel for an internal combustion engine.

To solve the above-described problem, the first invention of the present application is directed to an ignition device for use in an internal combustion engine that uses a flame-retardant fuel, including: a spark plug placed in a cylinder of the internal combustion engine; a discharge circuit that induces a high voltage in the spark plug to discharge the spark plug; and a control unit that controls a timing at which the spark plug is discharged by the discharge circuit, wherein the control unit causes the discharge circuit to discharge the spark plug a plurality of times while a piston performs a reciprocating operation once in the cylinder.

The second invention of the present application is directed to the ignition device according to the first invention, wherein the control unit causes the discharge circuit to perform main discharge of the spark plug before the piston is at a top dead center in the reciprocating operation of the piston, and the control unit causes the discharge circuit to perform preliminary discharge of the spark plug before the main discharge.

The third invention of the present application is directed to the ignition device according to the second invention, wherein the fuel is not ignited in the preliminary discharge.

The fourth invention of the present application is directed to the ignition device according to the second or third invention, wherein the control unit controls a timing of the preliminary discharge based on a pressure or a temperature in the cylinder.

The fifth invention of the present application is directed to the ignition device according to any of the first to fourth inventions, wherein the control unit causes the discharge circuit to perform main discharge of the spark plug before the piston is at a top dead center in the reciprocating operation of the piston, and the control unit causes the discharge circuit to perform additional discharge of the spark plug after the main discharge.

The sixth invention of the present application is directed to the ignition device according to the fifth invention, wherein the additional discharge is performed at a timing closer to a time when the piston is at the top dead center, than the main discharge.

The seventh invention of the present application is directed to the ignition device according to the fifth or sixth invention, wherein the control unit determines whether the fuel is ignited by the main discharge, and does not perform the additional discharge when it is determined that the fuel is ignited while performing the additional discharge when it is determined that the fuel is not ignited.

The eighth invention of the present application is directed to the ignition device according to the fifth or sixth invention, wherein the control unit stores therein a specific operating range in which the additional discharge is required to be performed, and does not perform the additional discharge when the internal combustion engine is not in the specific operating range while performing the additional discharge when the internal combustion engine is in the specific operating range.

The ninth invention of the present application is directed to the ignition device according to any of the first to eighth inventions, wherein the fuel includes ammonia.

According to the first to ninth inventions of the present application, the spark plug is discharged a plurality of times during an operation of compressing the fuel using the piston in the cylinder. This can enhance the ignition rate of the fuel.

Especially, according to the second invention of the present application, the preliminary discharge is performed before the main discharge, to increase the temperature of the spark plug. This allows the fuel to be properly ignited in the main discharge.

Especially, according to the third invention of the present application, the fuel can be prevented from starting burning in the preliminary discharge.

Especially, according to the fourth invention of the present application, the control unit does not perform the preliminary discharge at a fixed timing, but dynamically controls the timing of the preliminary discharge. Thus, the preliminary discharge can be performed at a suitable timing in accordance with the circumstances.

Especially, according to the fifth invention of the present application, when the ignition is not achieved in the main discharge, the fuel can be ignited by the additional discharge.

Especially, according to the sixth invention of the present application, the additional discharge is performed at a time closer to the time when the piston is at the top dead center at which the pressure and the temperature of the fuel are high, than the main discharge. This can enhance the ignition rate of the fuel.

Especially, according to the seventh invention of the present application, the additional discharge is performed only when the fuel is not ignited in the main discharge. This can reduce wasteful power consumption.

Especially, according to the eighth invention of the present application, the additional discharge can be performed without detection of whether the fuel is ignited in the main discharge.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a configuration of a system including an ignition device and an internal combustion engine;

FIG. 2 is a flowchart showing a flow of operations according to a first preferred embodiment;

FIG. 3 is a graph showing a change in a pressure in a cylinder during the operations shown in FIG. 2;

FIG. 4 is a graph showing a relationship between a temperature of an air-fuel mixture and ignitability;

FIG. 5 is a flowchart showing a flow of operations according to a second preferred embodiment;

FIG. 6 is a graph showing a change in a pressure in a cylinder during the operations shown in FIG. 5; and

FIG. 7 is a flowchart showing a flow of operations according to a third preferred embodiment.

### DESCRIPTION OF THE PREFERRED EMBODIMENTS

Hereinafter, preferred embodiments of the present invention will be described with reference to the drawings.

### 1. Configuration of Ignition Device

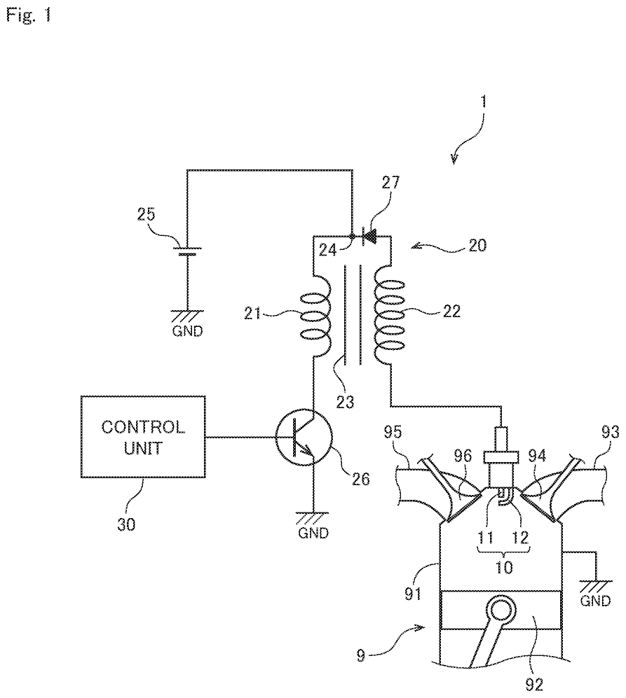

FIG. 1 is a view showing a configuration of a system including an ignition device 1 and an internal combustion engine 9 according to one preferred embodiment of the present invention. The ignition device 1 is a device that is mounted in an automobile and ignites a fuel supplied to a cylinder 91 of the internal combustion engine 9.

The internal combustion engine 9 includes the cylinder 91 serving as a combustion chamber and a piston 92 that compresses a fuel in the cylinder. The cylinder 91 is connected to an intake pipe 93 and an exhaust pipe 95. A connection portion between the intake pipe 93 and the cylinder 91 is provided with an intake valve 94. When the piston 92 moves downward with the intake valve 94 being opened, an air-fuel mixture containing a fuel is supplied from the intake pipe 93 into the cylinder 91. A connection portion between the exhaust pipe 95 and the cylinder 91 is provided with an exhaust valve 96. When the piston 92 moves upward with the exhaust valve 96 being opened, a gas in the cylinder 91 is exhausted to the exhaust pipe 95. Further, when the piston 92 moves upward with the intake valve 94 and the exhaust valve 96 being closed, an air-fuel mixture in the cylinder 91 is compressed. In the present embodiment, ammonia (NH₃) that is flame-retardant is used as a fuel.

As shown in FIG. 1, the ignition device 1 includes a spark plug 10, a discharge circuit 20, and a control unit 30.

The spark plug 10 is placed in the cylinder 91 of the internal combustion engine 9. The spark plug 10 includes a center electrode 11 and a ground electrode 12. The center electrode 11 is electrically connected to a secondary coil 22 described later. The ground electrode 12 is grounded from an engine block to the earth via the cylinder 91.

The discharge circuit 20 is an electric circuit that induces a high voltage in the spark plug 10, to thereby cause discharge between the center electrode 11 and the ground electrode 12. As shown in FIG. 1, the discharge circuit 20 includes a primary coil 21 and the secondary coil 22. The primary coil 21 and the secondary coil 22 are electromagnetically coupled to each other via an iron core 23. The number of turns of the secondary coil 22 is larger than the number of turns of the primary coil 21.

The primary coil 21 has one end electrically connected to a battery 25 via a connection portion 24. The battery 25 is a storage battery that can supply direct-current power. The other end of the primary coil 21 is grounded to the earth via a switching element 26. As the switching element 26, an insulated-gate bipolar transistor (IGBT) is used, for example.

The secondary coil 22 has one end electrically connected to the connection portion 24 via a diode 27. The diode 27 is connected such that a direction from the secondary coil 22 toward the connection portion 24 is a forward direction. The other end of the secondary coil 22 is electrically connected to the center electrode 11 of the spark plug 10 as described above.

The control unit 30 is a unit for controlling an operation of discharging the spark plug 10 performed by the discharge circuit 20. The control unit 30 includes a microcontroller or a computer including a CPU and a memory. The control unit 30 is an engine control unit (ECU) mounted in an automobile, for example. However, the control unit 30 may be a control board connected at a lower level with respect to the ECU. The control unit 30 controls the state of the switching element 26 between ON and OFF by outputting a control signal to the switching element 26.

### 2. Operations of Ignition Device

### 2-1. First Preferred Embodiment

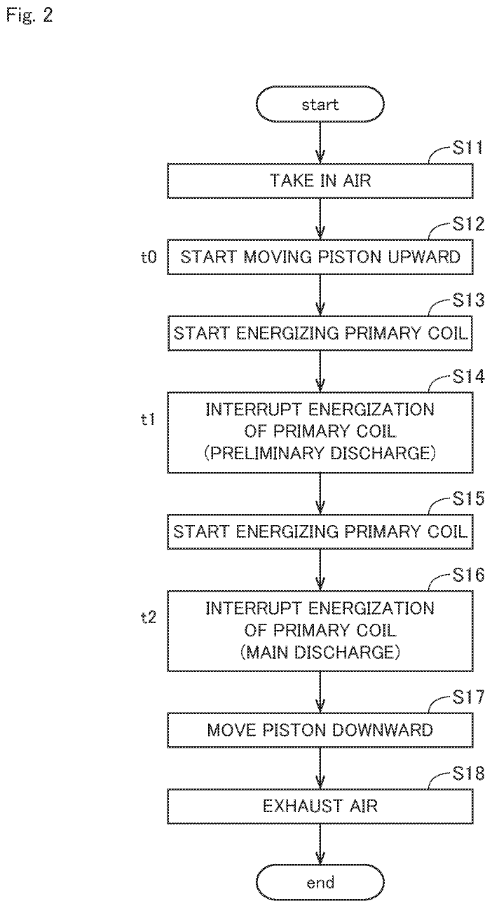

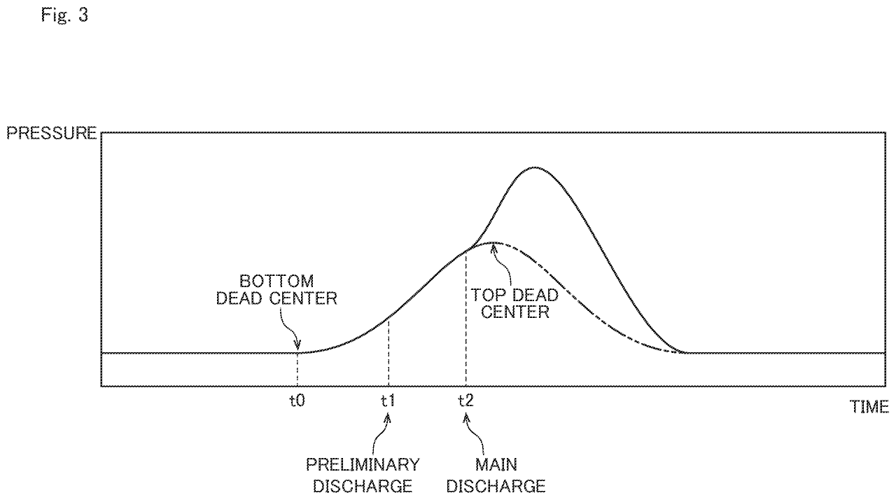

Next, operations of the above-described ignition device 1 will be described. FIG. 2 is a flowchart showing a flow of operations of the ignition device 1 and the internal combustion engine 9 according to a first preferred embodiment. FIG. 3 is a graph showing a change in a pressure in the cylinder 91 during the operations shown in FIG. 2. A horizontal axis in FIG. 3 represents a time. A vertical axis in FIG. 3 represents a pressure in the cylinder 91. Note that, in FIG. 3, a change in a pressure in a case where a fuel in the cylinder 91 fails to be ignited is indicated by a virtual line (alternate long and short dashes line), and a change in a pressure in a case where a fuel is successfully ignited is indicated by a solid line.

The ignition device 1 and the internal combustion engine 9 repeatedly perform the operations shown in FIG. 2. In a case where the internal combustion engine 9 is a four-cycle engine, the piston 92 reciprocates twice in the cylinder 91 during the operations of steps S11 to S18 in FIG. 2. Specifically, the piston 92 reciprocates once during the steps S12 to S17 in FIG. 2, and the piston 92 reciprocates once during the steps S18 to S11.

The internal combustion engine 9 opens the intake valve 94, first, and moves the piston 92 from the top dead center to the bottom dead center, to thereby supply an air-fuel mixture containing a fuel from the intake pipe 93 into the cylinder 91 (step S11). At a time t0 in FIG. 3, the piston 92 is positioned at the bottom dead center. At the time t0, the internal volume of the cylinder 91 has its maximum value, and the cylinder 91 is filled with an unburnt air-fuel mixture. The piston 92 starts moving from the bottom dead center to the top dead center (step S12). Further, the internal combustion engine 9 closes the intake valve 94. As a result, the air-fuel mixture starts being compressed.

At the time t0, the switching element 26 of the discharge circuit 20 is in an OFF state (open state). After the time t0, the control unit 30 starts energizing the primary coil 21 (step S13). Specifically, the control unit 30 switches the state of the switching element 26 from OFF to ON (closed state). This causes a current to flow from the battery 25 to the earth via the connection portion 24, the primary coil 21, and the switching element 26. At that time, due to the electromagnetic coupling between the primary coil 21 and the secondary coil 22, a voltage is about to be generated in the secondary coil 22, but the diode 27 prevents a current from flowing from the battery 25 to the secondary coil 22. Thus, a voltage is prevented from being generated in the center electrode of the spark plug 10. When the primary coil 21 is energized, primary energy is accumulated as the current flows through the primary coil 21.

Subsequently, at a time t1, the control unit 30 switches the state of the switching element 26 from ON to OFF. As a result, the energization of the primary coil 21 is interrupted (step S14). Thus, a high voltage corresponding to the above-described primary energy is induced in the secondary coil 22. Consequently, a high voltage is generated between the center electrode 11 and the ground electrode 12 of the spark plug 10. Then, due to the high voltage, spark discharge occurs between the center electrode 11 and the ground electrode 12.

The discharge at the time t1 is “preliminary discharge” preceding discharge that is performed for ignition at a time t2. As shown in FIG. 3, at the time t1, a pressure of the air-fuel mixture in the cylinder 91 does not sufficiently increase. Hence, also the temperature of the air-fuel mixture does not sufficiently increase. Thus, the fuel in the air-fuel mixture is not ignited by the preliminary discharge at the time t1. However, the temperatures of the center electrode 11 and the ground electrode 12 of the spark plug 10 and the periphery thereof are increased by the preliminary discharge. The preliminary discharge may be performed a plurality of times between the time t0 and the time t2.

Subsequently, the control unit 30 starts energizing the primary coil 21 again (step S15). Specifically, the control unit 30 switches the state of the switching element 26 from OFF to ON. This causes a current to flow from the battery 25 to the earth via the connection portion 24, the primary coil 21, and the switching element 26 in the same manner as in the step S13. Then, when the primary coil 21 is energized, primary energy is accumulated as the current flows through the primary coil 21.

Thereafter, at the time t2 before a time when the piston 92 reaches the top dead center, the control unit 30 switches the state of the switching element 26 from ON to OFF. As a result, the energization of the primary coil 21 is interrupted (step S16). Thus, a high voltage corresponding to the above-described primary energy is induced in the secondary coil 22. Consequently, a high voltage is generated between the center electrode 11 and the ground electrode 12 of the spark plug 10. Then, due to the high voltage, spark discharge occurs between the center electrode 11 and the ground electrode 12.

The discharge at the time t2 is “main discharge” that is performed for ignition. As shown in FIG. 3, at the time t2, the pressure of the air-fuel mixture in the cylinder 91 increases and becomes higher than that at the time t1. Hence, also the temperature of the air-fuel mixture at the time t2 is higher than that at the time t1. Thus, in the main discharge at the time t2, the fuel in the air-fuel mixture is easily ignited by sparks occurring between the center electrode 11 and the ground electrode 12.

Especially, the temperatures of the center electrode 11 and the ground electrode 12 are increased in advance by the above-described preliminary discharge. Further, because of the increase of the temperatures of the center electrode 11 and the ground electrode 12, also the temperature of a fuel present near those electrodes is increased. Thus, the fuel in the air-fuel mixture is properly ignited easily by sparks occurring in the main discharge. Therefore, an ignition rate of a flame-retardant fuel can be enhanced.

When ignition is successfully achieved and the fuel starts burning, the pressure in the cylinder 91 increases and the piston 92 moves from the top dead center to the bottom dead center (step S17). Subsequently, the internal combustion engine 9 opens the exhaust valve 96. Further, the piston 92 moves from the bottom dead center to the top dead center. As a result, a burnt gas in the cylinder 91 is exhausted to the exhaust pipe 95 (step S18).

As described above, the control unit 30 of the ignition device 1 causes the discharge circuit 20 to discharge the spark plug 10 a plurality of times while the piston 92 performs a reciprocating operation once in the cylinder 91. This can enhance an ignition rate of a flame-retardant fuel. Especially, in the present embodiment, preliminary discharge of the spark plug 10 is performed by the discharge circuit 20 before main discharge. Thus, the main discharge can be performed with the temperatures of the center electrode 11 and the ground electrode 12 of the spark plug 10 having been increased in advance. This allows a flame-retardant fuel to be properly ignited in the main discharge.

Meanwhile, the control unit 30 controls a timing (the time t1) of the preliminary discharge so that the fuel is not ignited by the above-described preliminary discharge. Specifically, the control unit 30 controls the timing of the preliminary discharge based on the pressure or the temperature in the cylinder 91.

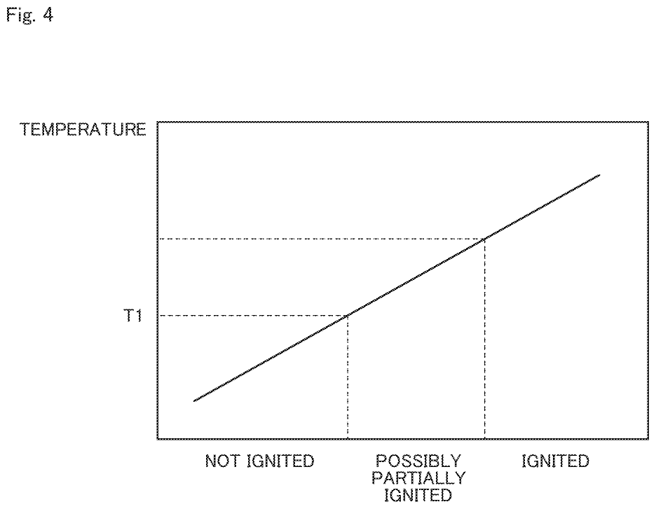

FIG. 4 is a graph showing a relationship between the temperature of the air-fuel mixture and the ignitability of the fuel. A vertical axis in FIG. 4 represents the temperature of the air-fuel mixture. A horizontal axis in FIG. 4 represents the ignitability. As shown in FIG. 4, when the temperature of the air-fuel mixture is lower than a predetermined temperature T1, the fuel in the air-fuel mixture is not ignited. Thus, the control unit 30 detects or calculates the temperature of the air-fuel mixture in the cylinder 91, and performs preliminary discharge when the temperature of the air-fuel mixture is equal to or lower than T1 at which ignition is not caused.

Further, the temperature in the cylinder 91 is correlated with the pressure in the cylinder 91. Hence, the control unit 30 may determine a timing of preliminary discharge based on the pressure in the cylinder 91. When a load on the internal combustion engine 9 is light (for example, at a time immediately after start-up of the internal combustion engine 9, or the like), the temperature in the cylinder 91 is low. When a load on the internal combustion engine 9 is heavy, the temperature in the cylinder 91 is high. Thus, the control unit 30 may determine a timing of preliminary discharge based on the operating condition of the internal combustion engine 9.

As described above, the control unit 30 does not perform preliminary discharge at a fixed timing, but dynamically controls a timing of preliminary discharge based on the operating condition of the internal combustion engine 9. As a result, preliminary discharge can be performed at a suitable timing in accordance with the circumstances. Consequently, a fuel can be prevented from starting burning due to preliminary discharge.

### 2-2. Second Preferred Embodiment

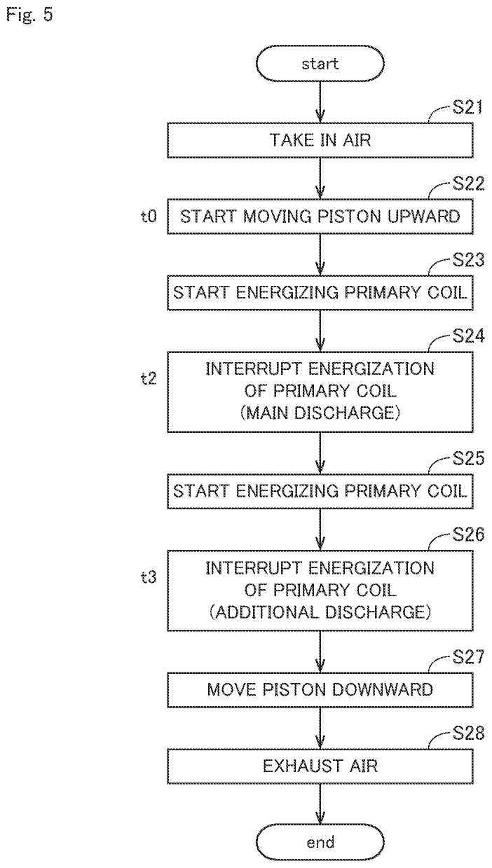

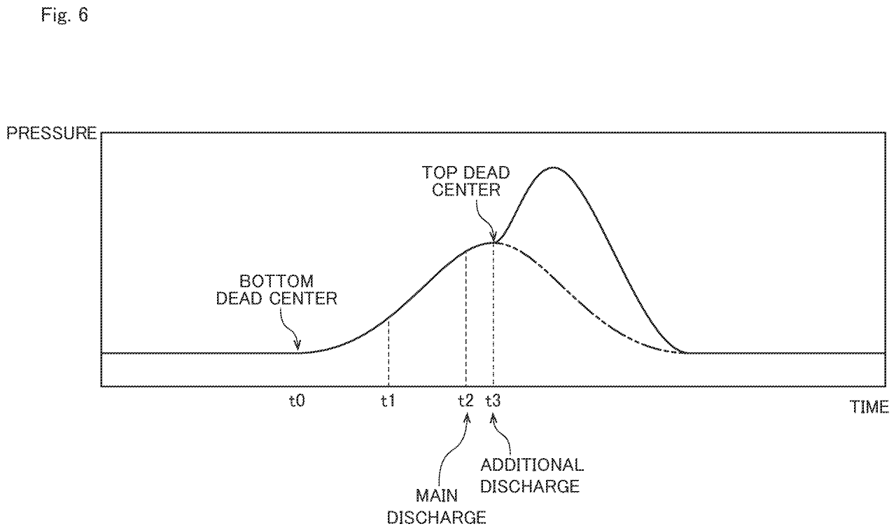

Next, a second preferred embodiment will be described. FIG. 5 is a flowchart showing a flow of operations of the ignition device 1 and the internal combustion engine 9 according to the second preferred embodiment. FIG. 6 is a graph showing a change in a pressure in the cylinder 91 during the operations shown in FIG. 5. Note that the following description will be given mainly about differences from the above-described first preferred embodiment.

The ignition device 1 and the internal combustion engine 9 repeatedly perform the operations shown in FIG. 5. In a case where the internal combustion engine 9 is a four-cycle engine, the piston 92 reciprocates twice in the cylinder 91 during operations of steps S21 to S28 in FIG. 5. Specifically, the piston 92 reciprocates once during the steps S22 to S27 in FIG. 5, and the piston 92 reciprocates once during the steps S28 to S21.

Also in the second preferred embodiment, the internal combustion engine 9 supplies an air-fuel mixture into the cylinder 91, first (step S21). Then, in the cylinder 91, the piston 92 starts moving from the bottom dead center to the top dead center (step S22). The operations of the steps S21 to S22 are similar to the operations of the steps S11 to S12 in the above-described first preferred embodiment, and hence detailed description thereof is omitted.

At the time t0, the switching element 26 of the discharge circuit 20 is in an OFF state. Further, in the present embodiment, the control unit 30 does not perform the above-described preliminary discharge performed at the time t1.

Before the time t2, the control unit 30 starts energizing the primary coil 21 (step S23). Specifically, the control unit 30 switches the state of the switching element 26 from OFF to ON. This causes a current to flow from the battery 25 to the earth via the connection portion 24, the primary coil 21, and the switching element 26. Then, when the primary coil 21 is energized, primary energy is accumulated as the current flows through the primary coil 21.

Subsequently, at the time t2 before a time when the piston 92 reaches the top dead center, the control unit 30 switches the state of the switching element 26 from ON to OFF. As a result, the energization of the primary coil 21 is interrupted (step S24). Thus, a high voltage corresponding to the above-described primary energy is induced in the secondary coil 22. Consequently, a high voltage is generated between the center electrode 11 and the ground electrode 12 of the spark plug 10. Then, due to the high voltage, spark discharge occurs between the center electrode 11 and the ground electrode 12.

The discharge at the time t2 is “main discharge” that is performed for ignition. However, because of the flame-retardancy of a fuel contained in the air-fuel mixture, ignition is not achieved by the main discharge in some cases. In such a case, as shown in FIG. 6, the pressure of the air-fuel mixture in the cylinder 91 does not rapidly increase, but moderately increases after the discharge at the time t2.

Thus, in the second preferred embodiment, the control unit 30 starts energizing the primary coil 21 again after the main discharge (step S25). Specifically, the control unit 30 switches the state of the switching element 26 from OFF to ON. This causes a current to flow from the battery 25 to the earth via the connection portion 24, the primary coil 21, and the switching element 26 in the same manner as in the step S23. Then, when the primary coil 21 is energized, primary energy is accumulated as the current flows through the primary coil 21.

Thereafter, the control unit 30 switches the state of the switching element 26 from ON to OFF at a time t3 closer to the time when the piston is at the top dead center, than the main discharge. As a result, the energization of the primary coil 21 is interrupted (step S26). Thus, a high voltage corresponding to the above-described primary energy is induced in the secondary coil 22. Consequently, a high voltage is generated between the center electrode 11 and the ground electrode 12 of the spark plug 10. Then, due to the high voltage, spark discharge occurs between the center electrode 11 and the ground electrode 12. Note that, as shown in FIG. 6, the time t3 may coincide with the time when the piston is at the top dead center. Further, the time t3 may be after the time t2 and before the piston is at the top dead center, or may be slightly after the piston is at the top dead center.

The discharge at the time t3 is “additional discharge” that is performed in preparation for a situation where ignition is not achieved in the main discharge. As shown in FIG. 6, at the time t3, the pressure of the air-fuel mixture in the cylinder 91 increases and becomes higher than that at the time t2. Hence, also the temperature of the air-fuel mixture at the time t3 is higher than that at the time t2. Thus, in some cases, a fuel is ignited by the additional discharge at the time t3 though the fuel is not ignited by the main discharge at the time t2. This can enhance an ignition rate of a flame-retardant fuel.

When ignition is successfully achieved and the fuel starts burning, the pressure in the cylinder 91 increases and the piston 92 moves from the top dead center to the bottom dead center (step S27). Subsequently, the internal combustion engine 9 opens the exhaust valve 96. Further, the piston 92 moves from the bottom dead center to the top dead center. As a result, a burnt gas in the cylinder 91 is exhausted to the exhaust pipe 95 (step S28).

As described above, in the present embodiment, the control unit 30 causes the discharge circuit 20 to discharge the spark plug 10 twice while the piston 92 performs a reciprocating operation once in the cylinder 91. This can enhance an ignition rate of a flame-retardant fuel. Especially, in the present embodiment, after the main discharge, the additional discharge is performed at a time closer to the time when the piston is at the top dead center at which the pressure and the temperature of the air-fuel mixture are high, than the main discharge. Consequently, the fuel can be ignited by the additional discharge even when ignition is not achieved by the main discharge.

The control unit 30 may determine whether a fuel is ignited by main discharge based on detection values of various sensors (for example, a sensor that detects the pressure in the cylinder 91 and a sensor that detects the presence or absence of burning using an ion current). Then, the control unit 30 may omit additional discharge when it is determined that the fuel is ignited by the main discharge, and may perform additional discharge only when it is determined that the fuel is not ignited by the main discharge. To perform additional discharge only when necessary as described above can reduce wasteful power consumption.

Further, the control unit 30 may store therein a specific operating range in which additional discharge should be performed, in advance. The specific operating range is an operating range in which a fuel is under the conditions that make it difficult to ignite the fuel in the cylinder 91. For example, suppose that an automobile has a plurality of driving modes. Then, in a case where it is previously known that burning in the cylinder 91 becomes unstable in some of the above-described plurality of driving modes (for example, driving modes in which a fuel becomes lean, such as lean burn and exhaust gas recirculation), the corresponding driving modes may be set as the above-described specific operating range. Then, the control unit 30 may omit additional discharge when the internal combustion engine 9 is not in the above-described specific operating range, and may perform additional discharge when the internal combustion engine 9 is in the above-described specific operating range. In this manner, additional discharge can be performed without detection of whether a fuel is ignited in main discharge.

### 2-3. Third Preferred Embodiment

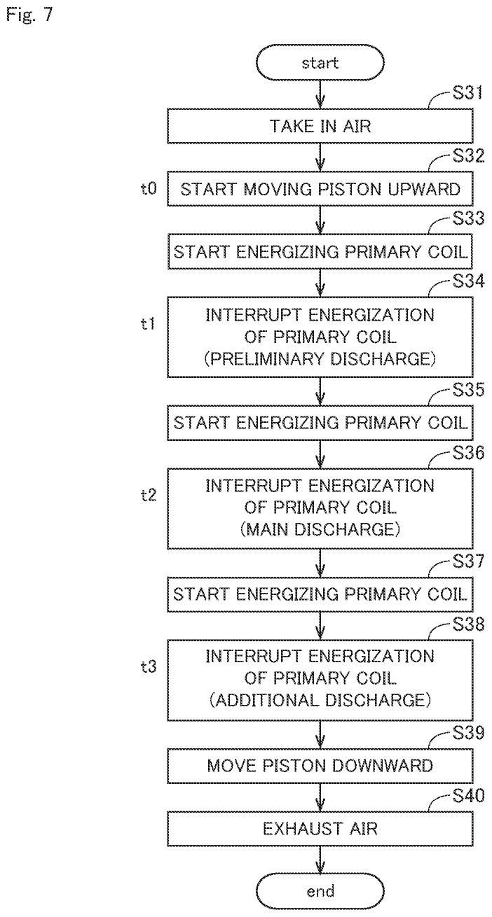

Next, a third preferred embodiment will be described. FIG. 7 is a flowchart showing a flow of operations of the ignition device 1 and the internal combustion engine 9 according to the third preferred embodiment. In the third preferred embodiment, all of the preliminary discharge at the time t1, the main discharge at the time t2, and the additional discharge at the time t3 are performed.

As shown in FIG. 7, the internal combustion engine 9 supplies an air-fuel mixture into the cylinder 91, first (step S31). Then, in the cylinder 91, the piston 92 starts moving from the bottom dead center to the top dead center (step S32). The operations of the steps S31 to S32 are similar to the operations of the steps S11 to S12 and the steps S21 to S22 described above, and hence detailed description thereof is omitted.

Subsequently, the ignition device 1 starts energizing the primary coil 21 (step S33), and interrupts the energization of the primary coil 21 at the time t1, to perform preliminary discharge (step S34). The operations of the steps S33 to S34 are similar to the operations of the steps S13 to S14 described above, and hence detailed description thereof is omitted.

Subsequently, the ignition device 1 starts energizing the primary coil 21 again (step S35), and interrupts the energization of the primary coil 21 at the time t2, to perform main discharge (step S36). The operations of the steps S35 to S36 are similar to the operations of the steps S15 to S16 and the steps S23 to S24 described above, and hence detailed description thereof is omitted.

Subsequently, the ignition device 1 starts energizing the primary coil 21 again (step S37), and interrupts the energization of the primary coil 21 at the time t3, to perform additional discharge (step S38). The operations of the steps S37 to S38 are similar to the operations of the steps S25 to S26 described above, and hence detailed description thereof is omitted.

When ignition is successfully achieved by the main discharge or the additional discharge and the fuel starts burning, the pressure in the cylinder 91 increases and the piston 92 moves from the top dead center to the bottom dead center (step S39). Thereafter, the internal combustion engine 9 opens the exhaust valve 96. Further, the piston 92 moves from the bottom dead center to the top dead center. As a result, a burnt gas in the cylinder 91 is exhausted to the exhaust pipe 95 (step S40).

As described above, in the present embodiment, the control unit 30 causes the discharge circuit 20 to discharge the spark plug 10 three times while the piston 92 performs a reciprocating operation once in the cylinder 91. Thus, it is possible to attain both of the effect of enhancing an ignition rate by the preliminary discharge and the effect of enhancing an ignition rate by the additional discharge. Therefore, an ignition rate of a flame-retardant fuel can be further enhanced.

### 3. Modifications

The first to third preferred embodiments of the present invention have been described above, but the present invention is not limited to the above-described embodiments.

In the above-described embodiments, ammonia has been cited as an example of a flame-retardant fuel. However, the “flame-retardant fuel” of the present invention is not limited to ammonia. For example, the “flame-retardant fuel” may be low-density gasoline or a low-density mixed fuel of hydrogen and ammonia.

Further, the above-described embodiments have discussed the case where the internal combustion engine 9 is a four-cycle engine. However, an internal combustion engine to which the ignition device of the present invention is applied is not necessarily limited to a four-cycle engine, and may be a two-cycle engine or the like.

Moreover, the above-described embodiments have discussed the ignition device 1 mounted in an automobile. However, the “ignition device” of the present invention may be mounted in transportation equipment other than an automobile. Further, the “ignition device” of the present invention may be mounted in an industrial machine or a power generator other than transportation equipment.

Furthermore, regarding details of the configurations of the ignition device and the internal combustion engine, changes may be appropriately made within a range not departing from the gist of the present invention. Further, the respective elements described in the above-described embodiments and modifications may be appropriately combined unless contradiction arises.

While the invention has been shown and described in detail, the foregoing description is in all aspects illustrative and not restrictive. It is therefore understood that numerous modifications and variations can be devised without departing from the scope of the invention.

1. An ignition device for use in an internal combustion engine that uses a fuel including a flame-retardant fuel, comprising:
a spark plug placed in a cylinder of the internal combustion engine;
a discharge circuit that induces a high voltage in the spark plug to discharge a spark; and
a processor programmed to control the discharge circuit to cause the spark plug to discharge the spark a plurality of times during one reciprocating cycle of a piston in the cylinder,
wherein the processor is further programmed to:
control the discharge circuit to perform main discharge of the spark plug before the piston reaches a top dead center in the one reciprocating cycle of the piston;
control the discharge circuit to perform preliminary discharge of the spark plug before the main discharge and after the piston passes a bottom dead center; and
control the discharge circuit to perform additional discharge of the spark plug after the main discharge.

2. (canceled)

3. The ignition device according to claim 1, wherein the fuel is not ignited in the preliminary discharge.

4. The ignition device according to claim 1, wherein the processor controls a timing of the preliminary discharge based on a pressure or a temperature in the cylinder.

5. (canceled)

6. The ignition device according to claim 1, wherein the additional discharge is performed at a timing closer to a time when the piston is at the top dead center than the main discharge.

7. The ignition device according to claim 1, wherein the processor is further programed to:
determine whether the fuel is ignited by the main discharge;
in response to determining that the air-fuel mixture is ignited, not cause the discharge circuit to perform the additional discharge of the spark plug; and
in response to determining that the air-fuel mixture is not ignited, cause the discharge circuit to perform the additional discharge of the spark plug.

8. The ignition device according to claim 1, wherein
the processor stores therein a specific operating range in which the additional discharge is required to be performed, and
the processor is further programed to:
in response to the internal combustion engine being not in the specific operating range, not cause the discharge circuit to perform the additional discharge of the spark plug; and
in response to the internal combustion engine being in the specific operating range, cause the discharge circuit to perform the additional discharge of the spark plug.

9. The ignition device according to claim 1, wherein the fuel includes ammonia.
